(19) United States
(12) Patent Application Publication
(10) Pub. No.: US 2007/0273932 A1
(43) Pub. Date: Nov. 29, 2007

(54) Method for providing a self-designed image on a clock via a digital printer

(76) Inventor: Chris Chen, Chino Hills, CA (US)

Correspondence Address: BACON & THOMAS, PLLC, 625 SLATERS LANE, FOURTH FLOOR, ALEXANDRIA, VA, 22314, US

(21) Appl. No.: 11/441,070

(22) Filed: May 26, 2006

(51) Int. Cl. G06F 15/00

(52) U.S. Cl. 358/3.29; 358/1.9

(57) ABSTRACT

A method for providing a self-designed image on a clock surface includes the steps necessary to form the image on the clock surface. The user chooses any kind of image he/she likes to be printed on the clock surface. After the image is chosen, the image is digitized and processed to have a dimension the same as that of the clock surface. A piece of paper having seams formed on a top side and adhesive on the other side is prepared. Then the processed image is printed on top of the piece of paper. The piece of paper is processed to remove or cut-off the additional parts at the seams to leave only the image-printed portion. Due to the adhesive on the back of the paper, the user is able to attach the piece of paper on the clock surface to complete the method.

### BACKGROUND OF THE INVENTION

1. Field of the Invention

The present invention relates to a method for providing a self-designed image on a clock, and more particularly to a method for providing a customized image on a pre-designed piece of paper so that the user is able to attach the pre-designed piece of paper on a clock surface.

2. Description of the Prior Art

An existing clock normally has a plain surface, a minute hand and a second hand. Therefore, it is quite dull and boring to send a clock as a gift to a friend. In addition, beside telling time, it seems that a clock has no other purposes.

Therefore, in order to add in further functions to the conventional clock and to increase the fun of having a clock, the present invention aims at providing a method for providing a self-designed image on the clock surface such that the recipient of the clock will always know who the giver is whenever the clock is presented.

### SUMMARY OF THE INVENTION

The primary objective of the present invention is to provide a method for providing a self-designed image on a clock surface.

In one aspect of the present invention, the method of the present invention include the following steps:

preparing a clock having a minute hand and a second hand;

choosing a image;

processing the image to correspond to a size of the clock as well as the size of the minute hand and the second hand;

printing the processed image on a pre-designed piece of paper having seams formed thereon;

processing the piece of paper to match the size of the clock; and

attaching the processed piece of paper on the clock surface.

Other objects, advantages and novel features of the invention will become more apparent from the following detailed description when taken in conjunction with the accompanying drawings.

### BRIEF DESCRIPTION OF THE DRAWINGS

FIG. 1 is a flow chart showing the steps of the method of the present invention;

FIG. 2 is a perspective view showing the structure of the piece of paper used in the method of the present invention;

FIG. 3 is a perspective view showing that the paper in use is in a roll;

FIG. 4 is an exploded perspective view showing that the piece of paper of the present invention is attached to a clock surface;

FIG. 5 is an exploded perspective view showing that a transparent film is provided on top of the clock surface; and

FIG. 6 is an exploded perspective view showing that the transparent film is combined with the second hand in the clock.

### DETAILED DESCRIPTION OF THE PREFERRED EMBODIMENT

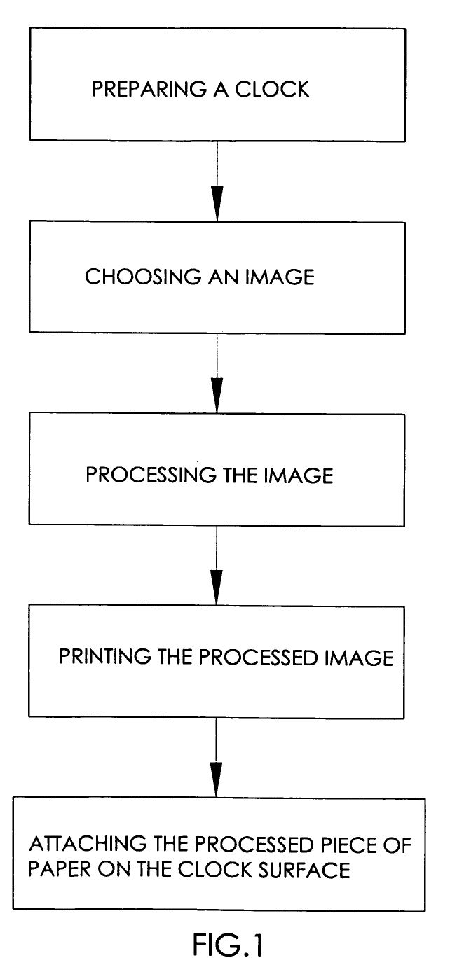

With reference to FIG. 1, it is noted that the method in accordance with the present invention includes the following steps:

1). preparing a clock having a minute hand and a second hand;

A clock having a plain surface, a minute hand and a second hand is prepared.

2). choosing an image;

The user may choose any kind of image he/she likes to be printed on the clock surface.

3). processing the image to correspond to a size of the clock as well as the size of the minute hand and the second hand;

After the image is chosen, the image is digitized and processed to have a dimension the same as that of the clock surface.

4). printing the processed image on a pre-designed piece of paper;

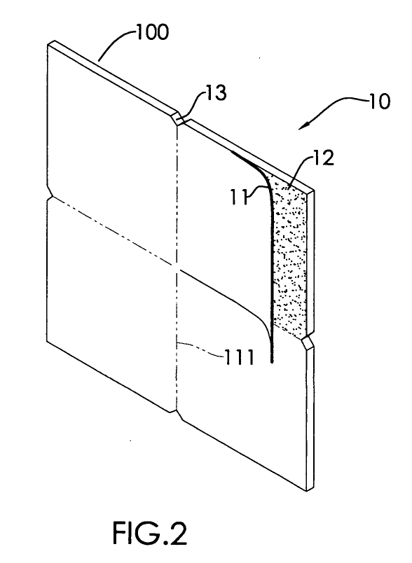

With reference to FIG. 2, a piece of paper (10) having a releasing paper (11) formed on a top side thereof and adhesive (12) is sandwiched between the releasing paper (11) and the top side. Then the processed image (100) is printed on a bottom side 12 of the piece of paper (10). The releasing paper (11) is provided with seams (111) formed thereon so that the releasing paper (11) is divided into segments (not numbered) to facilitate the application of the adhesive (12) after the segment of the releasing paper (11) is peeled off from the piece of paper (10).

5). attaching the processed piece of paper (10) on the clock surface.

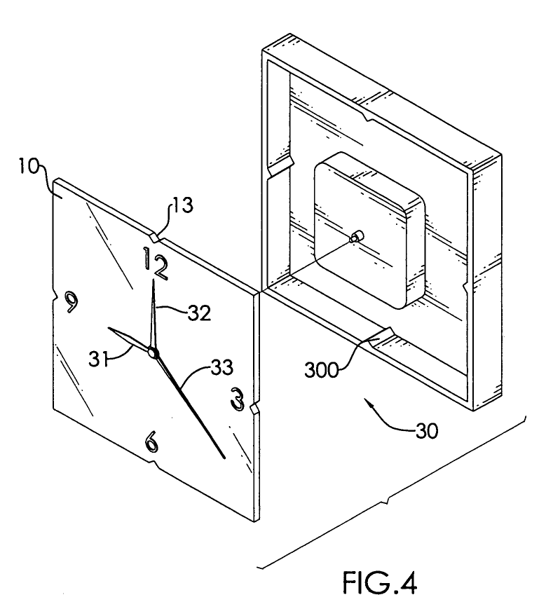

Due to the adhesive (12) on the bottom of the paper (10), the user is able to attach the piece of paper (10) on the clock surface to complete the method. Furthermore, due to the provision of the seams (111), the user is able to first attach a portion of the piece of paper (10) onto the clock surface and then uses positioning marks (13), such as cutouts or numerals or the like on the side faces of the piece of paper (10) as shown in FIG. 4 and protrusions or numerals or the like in the clock surface, to position the piece of paper (10) onto the clock surface.

Furthermore, the method also applies to the minute hand and the second hand.

That is, the user may choose the same image or a different image to be printed on the minute hand and the second hand so that the clock surface is provided with memorable images.

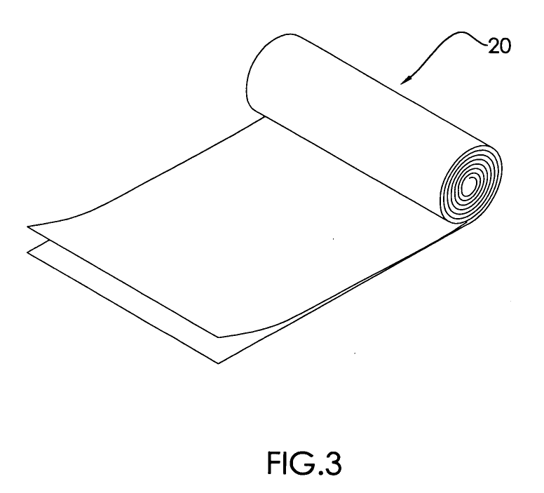

With reference to FIG. 3, when the paper is in a roll (20), a further step is added to the method of the present invention. That is, a step of processing the piece of paper to match the size of the clock is added. The piece of paper is processed to remove or cut-off the additional parts to leave only the image-printed portion. It is to be noted that when processing the paper in this embodiment, the releasing paper (21) on top of the piece of paper is also processed to match the size of the clock surface.

Referring to FIG. 4 again, it is noted that a clock (30) having the piece of paper (10) of the present invention attached thereon has an hour hand (31), a minute hand (32) and a second hand (33). After the piece of paper (10) is attached to the clock surface of the clock (30), the image on the bottom face of the piece of paper (10) is revealed for observation.

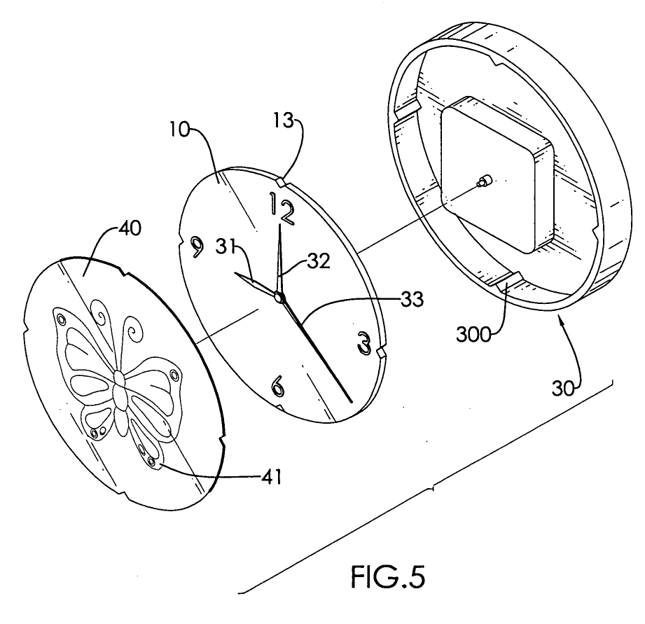

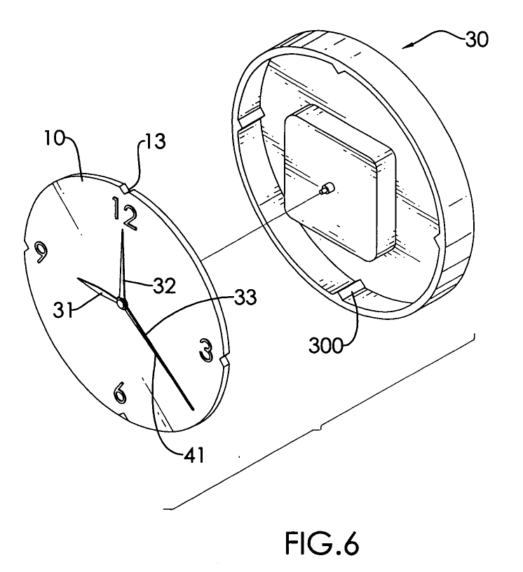

With reference to FIG. 5, it is noted that a transparent film (40) is applied on top of the clock surface and is driven by the mechanism of the clock (30). The transparent film (40) is provided with a second image (41) formed on a face of the transparent film (40) such that when the clock (30) is activated, the movement of the second hand (33) is synchronous with the movement of the transparent film (40). As a result of the contrast between the image (100) on the clock surface and the second image (41) on the transparent film (40) as the transparent film (40) moves, diversified patterns are created, which increases the entertainment objective of the clock. Still further, it is obvious that the transparent film (40) may be considered as the second hand (33). That is, the transparent film (40) is directly attached onto the second hand (33) to enable the second hand (33) to have the second image (41), as shown in FIG. 6.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for providing a self-designed image on a clock surface having a minute hand and a second hand on the clock surface, the method comprising the steps of:
choosing an image;
processing the image to correspond to a size of the clock surface;
printing the processed image on a side face of a pre-designed piece of paper; and
attaching the piece of paper on the clock surface.

2. The method as claimed in claim 1 further comprising the steps of:
choosing a second image;
processing the second image to correspond to a size of the minute hand;
printing the processed second image on the pre-designed piece of paper;
processing the piece of paper to match the size of the minute hand; and
detachably attaching the processed piece of paper on the minute hand.

3. The method as claimed in claim 2 further comprising the steps of:
choosing a third image;
processing the third image to correspond to a size of the second hand;
printing the processed third image on the pre-designed piece of paper having seams formed thereon;
processing the piece of paper to match the size of the second hand; and
attaching the processed piece of paper on the second hand.

4. The method as claimed in claim 1 further comprising a positioning step after the printing step, wherein the positioning step includes using first positioning marks on the piece of paper to align with second positioning marks on the clock surface.

5. The method as claimed in claim 2 further comprising a positioning step after the printing step, wherein the positioning step includes using first positioning marks on the piece of paper to align with second positioning marks on the clock surface.

6. The method as claimed in claim 3 further comprising a positioning step after the printing step, wherein the positioning step includes using first positioning marks on the piece of paper to align with second positioning marks on the clock surface.

7. The method as claimed in claim 6, wherein in the paper processing step, the piece of paper is first partially attached to the clock surface and then after alignment between the piece of paper and the clock surface is finished, the piece of paper is entirely attached to the clock surface.

8. The method as claimed in claim 7, wherein the piece of paper is composed of a releasing paper attached to a side face of the piece of paper opposite to the side face having thereon the image, the releasing paper has seams formed thereon to allow the releasing paper to be divided into segments such that the piece of paper is able to be partly attached to the clock surface.

9. The method as claimed in claim 8 further comprising a transparent film to be attached on the clock surface and being movable relative to the clock surface, the transparent film having a second image formed thereon.

10. A method for providing a self-designed image on a clock surface having a minute hand and a second hand on the clock surface, the method comprising the steps of:
choosing an image;
processing the image to correspond to a size of the clock;
printing the processed image on a side face of a pre-designed piece of paper;
processing a size of the piece of paper to match a dimension of the clock surface; and
attaching the processed piece of paper on the clock surface.

11. The method as claimed in claim 10 further comprising the steps of:
choosing a second image;
processing the second image to correspond to a size of the minute hand;
printing the processed second image on the pre-designed piece of paper;
processing the piece of paper to match the size of the minute hand; and
attaching the processed piece of paper on the minute hand.

12. The method as claimed in claim 11 further comprising the steps of:
choosing a third image;
processing the third image to correspond to a size of the second hand;
printing the processed third image on the pre-designed piece of paper having seams formed thereon;
processing the piece of paper to match the size of the second hand; and
attaching the processed piece of paper on the second hand.

13. The method as claimed in claim 10 further comprising a positioning step after the printing step, wherein the positioning step includes using first positioning marks on the piece of paper to align with second positioning marks on the clock surface.

14. The method as claimed in claim 11 further comprising a positioning step after the printing step, wherein the positioning step includes using first positioning marks on the piece of paper to align with second positioning marks on the clock surface.

15. The method as claimed in claim 12 further comprising a positioning step after the printing step, wherein the positioning step includes using first positioning marks on the piece of paper to align with second positioning marks on the clock surface.

16. The method as claimed in claim 15, wherein in the paper processing step, the piece of paper is first partially attached to the clock surface and then after alignment between the piece of paper and the clock surface is finished, the piece of paper is entirely attached to the clock surface.

17. The method as claimed in claim 16, wherein the piece of paper is composed of a releasing paper attached to a side face of the piece of paper opposite to the side face having thereon the image, the releasing paper has seams formed thereon to allow the releasing paper to be divided into segments such that the piece of paper is able to be partly attached to the clock surface.
